(19) United States
(12) Patent Application Publication
(10) Pub. No.: US 2016/0091097 A1
(43) Pub. Date: Mar. 31, 2016

(54) PRESSURE REDUCING VALVE

(71) Applicant: KEIHIN CORPORATION, Tokyo (JP)

(72) Inventors: Hideki Kawauchi, Nikko-shi (JP); Hiroyasu Ozaki, Utsunomiya-shi (JP); Koichi Takaku, Tochigi-ken (JP)

(21) Appl. No.: 14/857,072

(22) Filed: Sep. 17, 2015

(30) Foreign Application Priority Data
Sep. 26, 2014 (JP) 2014-197103

(51) Int. Cl. F16K 1/34; F16K 31/12

(52) U.S. Cl. CPC F16K 1/34; F16K 31/12

(57) ABSTRACT

In a pressure reducing valve, a piston is disposed in a piston slide hole of a body so as to be displaceable along an axial direction thereof. An o-ring is disposed through a second annular groove on an outer circumferential surface of the piston. First and second wear rings are disposed respectively in first and third annular grooves, which are distanced from the second annular groove respectively above and below with respect to the second annular groove. A distance along the axial direction between the first annular groove or the first wear ring and the second annular groove or the o-ring, and a distance along the axial direction between the third annular groove or the second wear ring and the second annular groove or the o-ring are set, respectively, to be greater than a stroke distance of the piston along the axial direction.

### CROSS-REFERENCE TO RELATED APPLICATION

This application is based upon and claims the benefit of priority from Japanese Patent Application No. 2014-197103 filed on Sep. 26, 2014, the contents of which are incorporated herein by reference.

### BACKGROUND OF THE INVENTION

1. Field of the Invention

The present invention relates to a pressure reducing valve, in which by displacement of a piston depending on a pressure in a decompression chamber, a fluid is reduced in pressure to attain a predetermined pressure.

2. Description of the Related Art

Heretofore, pressure reducing valves have been known, which function to reduce the pressure of a high-pressure fluid to a given predetermined pressure. Such a pressure reducing valve, for example as disclosed in Japanese Laid-Open Patent Publication No. 2013-206360, includes a piston that is disposed displaceably in a housing, and a valve element, which is disposed displaceably through a valve stem on a lower end surface of the piston. In addition, under an elastic force or action of a spring, the piston is displaced downwardly, whereby the valve element, through the valve stem, is moved away from a valve seat, and hydrogen gas is allowed to flow through the valve. On the other hand, when a pressure in the decompression chamber between a body and the lower end surface of the piston rises, the piston is pressed upwardly, and the valve element is pressed and seated on the valve seat by another spring, whereby flow of the hydrogen gas is blocked.

Further, in the aforementioned piston, an o-ring and a pair of wear rings are mounted through annular grooves that are formed in the outer circumferential surface of the piston. The wear rings are arranged on an upper side and a lower side along the direction of displacement of the piston, and the o-ring is arranged between the wear rings. Additionally, by the o-ring being in sliding contact with an inner wall surface of the housing, leakage of hydrogen gas between the piston and the inner wall surface is prevented, and by sliding contact of the pair of wear rings against the inner wall surface, the piston is guided along the axial direction.

### SUMMARY OF THE INVENTION

However, with the aforementioned pressure reducing valve, when the piston moves along the piston chamber of the housing, wear and abrasion occurs due to the sliding movement of the wear rings along the inner wall of the piston chamber, resulting in generation of abrasion debris. In addition, by the abrasion debris entering in between the o-ring and the inner wall, and the piston moving with the abrasion debris in such an inserted state, there is a concern that damage to the o-ring will occur.

As a result, if such damage occurs, fluid may leak to the outside of the piston chamber through wounds or scratches that occur in the o-ring, leading to deterioration in the sealing ability.

It is a general object of the present invention to provide a pressure reducing valve in which adhesion of debris particles or the like to a sealing member that is mounted in a piston is prevented, so that a stable sealing ability by the sealing member can be obtained.

A pressure reducing valve according to the present invention includes a body including an ingress passageway configured to introduce a fluid, a valve chamber held in fluid communication with the ingress passageway, a valve seat disposed in the valve chamber, a valve element being selectively seated on and separated away from the valve seat, a valve hole through which a valve rod with the valve element disposed thereon extends, a decompression chamber held in fluid communication with the valve chamber through the valve hole, and an egress passageway configured to deliver the fluid outside of the decompression chamber, a piston housed in the body, the piston being coupled to the valve rod for displacement depending on a change in pressure inside the decompression chamber, and a resilient member that resiliently urges the piston toward the valve seat.

On an outer circumferential wall of the piston, there are provided a seal groove in which there is disposed a sealing member that slides in contact with an inner circumferential wall of the body, and a ring groove in which there is disposed a ring member that slides in contact with the inner circumferential wall of the body.

At least one ring groove is disposed on at least one of one side and another side of the seal groove along the direction of displacement of the piston, and a displacement amount of the piston along the axial direction is less than a distance in the axial direction between the seal groove and the ring groove.

According to the present invention, in the pressure reducing valve in which the piston is disposed for displacement in the interior of the body, the sealing member is disposed through the seal groove, and the ring member is disposed through the ring groove on the outer circumferential wall of the piston. In addition, the displacement amount of the piston in the axial direction is less than the distance in the axial direction between the seal groove and the ring groove.

Consequently, by the displacement amount of the piston in the axial direction being less than the distance between the seal groove and the ring groove, even in the case that debris such as abrasion particles or the like is generated by sliding contact of the ring member with the body upon displacement of the piston, because the sealing member does not move up to the range within which the ring member undergoes sliding movement, such debris are reliably prevented from adhering to the sealing member.

As a result, scratches caused by adhesion of debris to the sealing member are prevented, and by preventing leakage of fluid through such scratches, deterioration in the sealing performance of the sealing member can be suppressed, and the sealing ability between the body and the piston by the sealing member can be stably maintained.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall cross-sectional view of a pressure reducing valve according to an embodiment of the present invention;

FIG. 2 is an overall cross-sectional view showing the pressure reducing valve shown in FIG. 1 in a valve closed state; and

FIG. 3 is an enlarged cross-sectional view of the vicinity of a piston in the pressure reducing valve shown in FIG. 1.

### DESCRIPTION OF THE PREFERRED EMBODIMENT

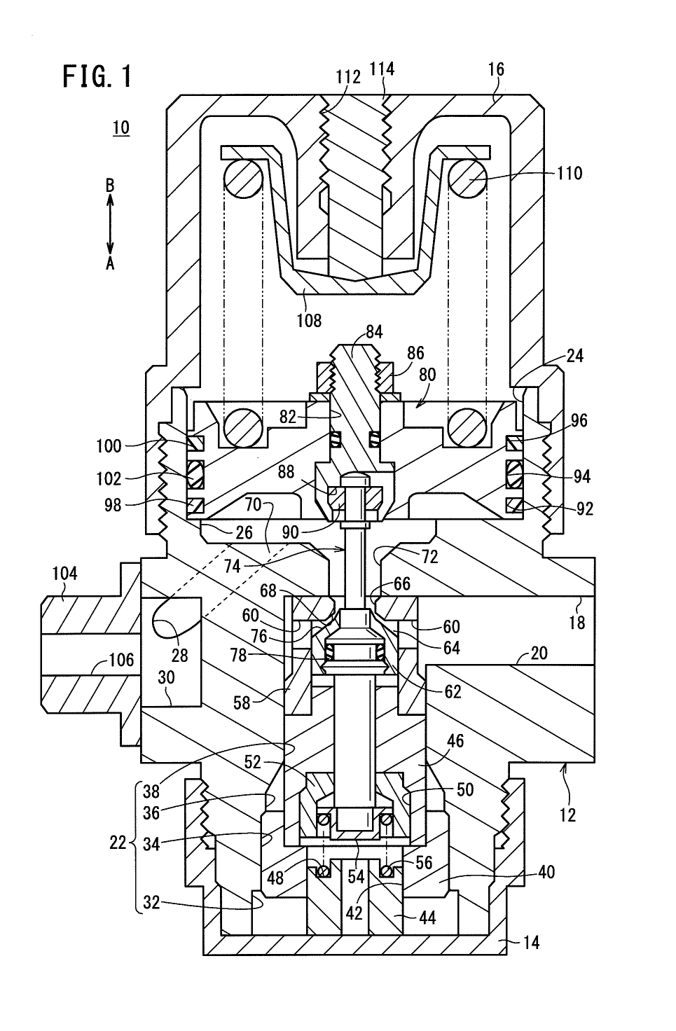

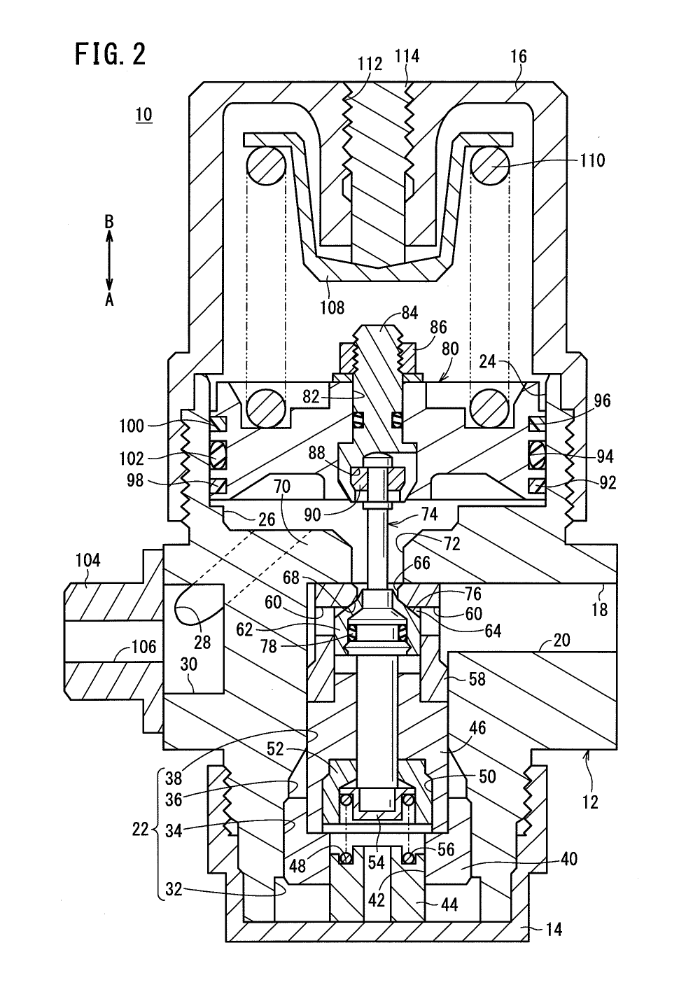

As shown in FIGS. 1 and 2, a pressure reducing valve includes a body 12 that opens upwardly and downwardly, a lower cover 14 mounted on a lower end (in the direction of the arrow A) of the body 12, and an upper cover 16 mounted on an upper end (in the direction of the arrow B) of the body 12.

The body 12 has an inlet port 18 that opens on one side of the body 12 and through which a fluid is introduced into the body 12, a housing hole 22 held in fluid communication with the inlet port 18 through an ingress passageway 20 that is formed in a substantially central portion of the body 12, a piston slide hole 24 that opens upwardly, and an egress passageway 28 for delivering the fluid out of a later-described decompression chamber 26, and an outlet port 30 held in fluid communication with the egress passageway 28. The outlet port 30 is formed in a position on an opposite side from the inlet port 18 across the housing hole 22.

The housing hole 22 includes a large-diameter hole 32 extending in a vertical direction (the direction of arrows A and B), and which is disposed lowermost (in the direction of the arrow A) and is largest in terms of its inside diameter, a medium-diameter hole 34 disposed upwardly with respect to the large-diameter hole 32 and which is somewhat smaller in diameter than the large-diameter hole 32, a tapered hole 36 disposed upwardly of the medium-diameter hole 34 and which becomes progressively smaller in diameter in an upward direction, and a small-diameter hole 38 disposed on an upper part of the tapered hole 36 and which is smallest in terms of the inside diameter thereof. The lower cover 14 is threaded over the lower end of the body 12, thereby closing the large-diameter hole 32.

A substantially cylindrical first holder 40 is press-fitted into the medium-diameter hole 34, and in a diametrical center portion of the first holder 40, an insertion hole 42 penetrates therethrough extending in the axial direction (the direction of arrows A and B). A collar 44 is inserted displaceably in the insertion hole 42. In the first holder 40, an end of a second holder 46 is inserted, and placed onto an upwardly opening stepped portion, such that the outer circumferential surface of the second holder 46 can slide in contact with the small-diameter hole 38.

The collar 44 is formed in a cylindrical shape, for example, and by the lower end thereof coming into abutment with the lower cover 14, falling out of the collar 44 downwardly (in the direction of the arrow A) from the insertion hole 42 is prevented. The collar 44 has an annular recess 48 defined in an upper end surface thereof, and which is positioned radially outward from the center.

The second holder 46 includes a housing section 50, which is recessed convexly on the lower end thereof confronting the collar 44. A retainer holder 52 is accommodated in the housing section 50, together with a first retainer 54 being accommodated in the interior of the cup-shaped retainer holder 52.

Additionally, a first spring (elastic member) 56 in the form of a coil spring is inserted between the first retainer 54 and the collar 44, and the first spring 56 biases or urges a valve rod 74 upwardly (in the direction of the arrow B) through the first retainer 54.

A substantially cylindrical guide member 58 is accommodated in the small-diameter hole 38 at a position above the second holder 46. The guide member 58 has a plurality of passage holes 60 defined therein, which penetrate in radial directions from an inner circumferential wall surface to an outer circumferential wall surface thereof. The plural passage holes 60 are disposed circumferentially along the guide member 58. For this reason, a fluid, which is introduced from the inlet port 18 and flows into the small-diameter hole 38 (housing hole 22), flows through the plural passage holes 60 and into the guide member 58. More specifically, the fluid flows into a valve chamber 64, which is defined between an outer wall surface of a later-described valve element 62 and an inner wall surface of the guide member 58.

Further, on the upper end of the guide member 58, a valve hole 66 is formed to penetrate therethrough in a substantially central portion. An opening of the valve hole 66 is formed in a tapered shape that gradually expands in diameter in a downward direction (the direction of the arrow A). Further, the opening of the valve hole 66, which is formed in a tapered shape, serves as a valve seat 68 which the valve element 62 can be seated on or separated away from.

On the other hand, between the piston slide hole 24 and the housing hole 22 in the body 12, an annular partition wall 70 is formed, which bulges out on a diametrical inner side. In a central portion of the partition wall 70, there is formed a communication hole 72, through which the housing hole 22 and the piston slide hole 24 are held in fluid communication with each other. The guide member 58 has an upper end surface, which is held in abutment against the lower end surface of the partition wall 70. The valve hole 66 and the communication hole 72 are collinear along a straight line and communicate with each other.

In addition, in the interior of the body 12, an elongate valve rod 74 is accommodated so as to pass through the valve hole 66 and the communication hole 72. A lower end of the valve rod 74, after being inserted through the interiors of the guide member 58 and the second holder 46, is connected to the first retainer 54. More specifically, the valve rod 74 is biased upwardly (in the direction of the arrow B) by the first spring 56 that is interposed between the first retainer 54 and the collar 44, or stated otherwise, is urged toward the valve seat 68.

Further, by rotating and screwing the lower cover 14, the lower cover 14 can be made to move in an axial direction toward or away from the body 12. For example, the first spring 56 is contracted by moving the lower cover 14 toward the body 12 (in the direction of the arrow B). Conversely, the first spring 56 is expanded by moving the lower cover 14 in a direction away from the body 12 (in the direction of the arrow A). Accordingly, in this manner, the elastic force (biasing force) that the first spring 56 applies to the valve rod 74 can be adjusted by changing the degree to which the first spring 56 is compressed or expanded.

Further, in a substantially central portion along the axial direction of the valve rod 74, the valve element 62 is formed, which is expanded radially outward in diameter. The valve element 62 includes a valve plug 76 formed in a tapered shape so as to become smaller in diameter in an upward direction (the direction of the arrow B). A seal ring 78 is mounted through an annular groove of the valve rod 74 on an inner circumferential surface of the valve element 62. When the valve rod 74 is displaced axially (in the direction of arrows A and B), the valve element 62 is displaced in unison with the valve rod 74, and when the valve element 62 is displaced upwardly (in the direction of the arrow B), the valve plug 76, which is formed in a tapered shape corresponding to the valve seat 68, is seated on the valve seat 68, thereby closing and blocking the valve hole 66.

In the piston slide hole 24, a substantially disk-shaped piston 80 is accommodated displaceably in the axial direction (the direction of arrows A and B). When the piston 80 is displaced downwardly (in the direction of the arrow A), the piston 80 abuts against the partition wall 70 to bring about a bottom dead center condition, whereby the valve is placed in a valve open state (see FIG. 1).

When the piston 80 shown in FIG. 2 rises or is displaced upwardly, the decompression chamber 26 is disposed between the partition wall 70 and a lower end surface of the piston 80. In addition, since the valve hole 66 and the communication hole 72 are held in fluid communication with each other, as shown in FIG. 1, when the valve hole 66 is open, the decompression chamber 26 is maintained in fluid communication with the valve chamber 64 through the valve hole 66 and the communication hole 72. Further, one end of the egress passageway 28 opens into the interior of the decompression chamber 26, and the other end communicates with the outlet port 30.

A piston hole 82 penetrates in the axial direction through the center of the piston 80, with an engagement member 84 being inserted therethrough. The engagement member 84 is connected integrally with the piston 80 by screw-engagement of a nut 86 onto a region of the engagement member 84 that projects upwardly through the piston hole 82.

Further, a radially-extending engagement groove 88 is formed on a lower end of the engagement member 84, and one end of the valve rod 74 engages with the engagement groove 88 in a state in which a C-shaped clip 90 is fitted onto the one end of the valve rod 74. Accordingly, the C-shaped clip 90 serves to couple the valve rod 74 and the engagement member 84 to each other.

On the other hand, as shown in FIGS. 1 through 3, first through third annular grooves 92, 94, 96, which are arranged along the axial direction (the direction of arrows A and B) while being separated by predetermined distances, are formed on the outer circumferential surface of the piston 80. The first through third annular grooves 92, 94, 96 are arranged substantially in parallel, such that the first annular groove (ring groove) 92 is disposed at a lowermost position (in the direction of the arrow A), and the third annular groove (ring groove) 96 is disposed at an uppermost position (in the direction of the arrow B).

Ring shaped first and second wear rings (ring members) 98, 100 are mounted respectively in the first and third annular grooves 92, 96. The first and second wear rings 98, 100 project slightly toward the outer side with respect to the outer circumferential surface of the piston 80, and are arranged in sliding contact with the inner circumferential surface of the piston slide hole 24, thereby serving to guide the piston 80 along the axial direction (the direction of arrows A and B). The first and second wear rings 98, 100 are formed from a resin material having a low coefficient of friction, for example.

An o-ring (sealing member) 102 is mounted in the second annular groove (seal groove) 94, and by being in sliding contact with the inner circumferential surface of the piston slide hole 24, prevents leakage of fluid from between the piston 80 and the piston slide hole 24. The o-ring 102 is formed from an elastic or resilient material such as rubber or the like.

More specifically, the o-ring 102 is disposed between the first wear ring 98 and the second wear ring 100, and is disposed at a position spaced from both the first wear ring 98 and the second wear ring 100. Stated otherwise, the o-ring 102 is arranged so as to be sandwiched between the first wear ring 98 and the second wear ring 100.

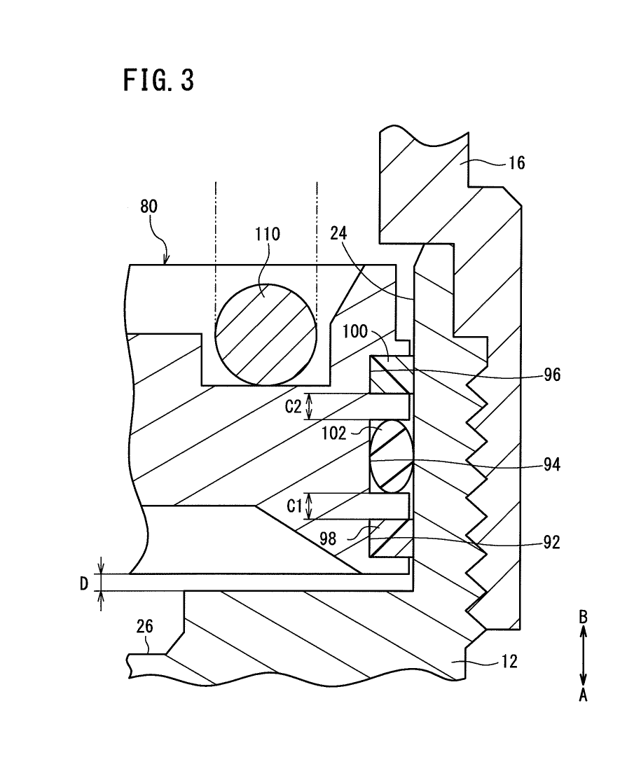

As shown in FIG. 3, a distance C1 along the axial direction (the direction of arrows A and B) between the first annular groove 92 and the second annular groove 94, or stated otherwise, the distance between the first wear ring 98 and the o-ring 102, is set to be greater than a stroke distance D of the piston 80 along the axial direction (C1>D). Similarly, a distance C2 along the axial direction (the direction of arrows A and B) between the third annular groove 96 and the second annular groove 94, or stated otherwise, the distance between the second wear ring 100 and the o-ring 102, is set to be greater than the stroke distance D of the piston 80 (C2>D).

The distance C1 between the first annular groove 92 and the second annular groove 94 may be the same as the distance C2 between the third annular groove 96 and the second annular groove 94 (C1=C2), or the distances C1 and C2 may be different from each other (C1≠C2). In other words, any arrangement may be used insofar as the distances C1 and C2 are greater than the stroke distance D of the piston 80 (C1, C2>D).

Further, although the first and second wear rings 98, 100 are provided with the object of guiding the piston 80 along the axial direction (the direction of arrows A and B) while preventing the piston 80 from coming into direct contact with the piston slide hole 24, at the same time, the first and second wear rings 98, 100 may also include a sealing function to maintain the sealing ability between the piston 80 and the piston slide hole 24. By having such a sealing function, it is possible for the sealing ability between the piston 80 and the body 12 to be increased further by the first and second wear rings 98, 100 in addition to the o-ring 102.

As shown in FIGS. 1 and 2, a gas outlet coupling 104 is connected to the outlet port 30. Gas that has reached the outlet port 30 through the decompression chamber 26 and the egress passageway 28 flows through an outlet passageway 106 that is defined in the gas outlet coupling 104, and then flows outside of the pressure reducing valve 10.

The piston slide hole 24 is closed by screw-engagement of the upper cover 16 on an upper part of the body 12, and in the interior of the upper cover 16, a second spring (resilient member) 110 is accommodated such that a lower end of the second spring 110 is seated on the piston 80, and an upper end thereof is seated on a second retainer 108. In addition, the piston 80 is urged by the second spring 110 toward the valve seat 68 (in the direction of the arrow A).

Further, an adjustment hole 112 is formed along the axial direction (the direction of arrows A and B) on a ceiling portion of the upper cover 16. An adjustment screw 114 is inserted so as to be capable of screw-rotation in the adjustment hole 112. By screw-rotation of the adjustment screw 114, the adjustment screw 114 undergoes advancing and retracting movements in the axial direction (the direction of arrows A and B), so that the position of the second retainer 108 can be changed under an action in contact with the adjustment screw 114. Consequently, the degree to which the second spring 110 is compressed or expanded can be changed, and as a result, the resilient force (biasing force) that is applied to the piston 80 from the second spring 110 can be adjusted.

The pressure reducing valve 10 according to the embodiment of the present invention is basically constructed as described above. Operations and advantages of the pressure reducing valve 10 will be described below.

The pressure reducing valve 10 is incorporated in a distribution line for a reactant gas, such as a hydrogen-containing gas, for example, that is used to operate a fuel cell. The distribution line may be a supply line for supplying a reactant gas to the fuel cell, or a discharge line for discharging a reactant gas from the fuel cell. In the explanation below, a case will be described in which such a reactant gas is used as the fluid.

The reactant gas is introduced from the inlet port 18, flows past the ingress passageway 20, and reaches the housing hole 22, whereupon the reactant gas further flows through the passage holes 60 formed in the guide member 58 and into the interior of the guide member 58, i.e., into the valve chamber 64.

In the case that the valve element 62 is in the initial position shown in FIG. 1 in which the valve element 62 is separated away from the valve seat 68, the reactant gas flows from the valve chamber 64, through the valve hole 66 and the communication hole 72, and into the decompression chamber 26. Further, on the inner circumferential surface of the valve element 62, the seal ring 78 is mounted through the annular groove of the valve rod 74.

In the case that the reactant gas is kept under a predetermined pressure or lower, and the sum of the pressing force applied to the piston 80 from the reactant gas and the biasing force applied to the valve rod 74 from the first spring 56 through the first retainer 54 is smaller than the biasing force applied to the piston 80 from the second spring 110, then the piston 80 is not displaced. In this case, the reactant gas flows from the decompression chamber 26, into the egress passageway 28, and then to the outlet port 30, from which the reactant gas flows through the outlet passageway 106 in the gas outlet coupling 104 and is guided outside of the pressure reducing valve 10.

Conversely, if the reactant gas is of a sufficiently high pressure, and the sum of the pressing force applied to the piston 80 from the reactant gas that has reached the decompression chamber 26 and the resilient biasing force applied to the valve rod 74 from the first spring 56 through the first retainer 54 is greater than the resilient biasing force applied to the piston 80 from the second spring 110, then the resilient force of the second spring 110 is overcome and the piston 80 is displaced upwardly (in the direction of the arrow B). Consequently, the valve rod 74 connected to the piston 80 is displaced upwardly together with the piston 80. Further, the second spring 110 is contracted, whereas the first spring 56 is expanded.

As a result, as shown in FIG. 2, the valve plug 76 of the valve element 62, which is fitted over the valve rod 74, is seated on the valve seat 68, thereby closing the valve seat 68. At this time, the valve chamber 64 and the decompression chamber 26 are shut off from each other, thereby closing the pressure reducing valve 10. Owing thereto, the reactant gas, which is discharged outside of the pressure reducing valve 10, is simply the reactant gas that already has entered the decompression chamber 26 prior to closing the pressure reducing valve 10.

When the reactant gas, which has entered the decompression chamber 26, flows through the egress passageway 28, the outlet port 30 and the outlet passageway 106, and is discharged outside of the pressure reducing valve 10, the pressure in the decompression chamber 26, i.e., the pressing force applied to the piston 80 from the reactant gas in the decompression chamber 26, is lowered. In addition, when the resilient biasing force of the second spring 110 exceeds the sum of the pressing force applied to the piston 80 and the biasing force applied to the valve rod 74 from the first spring 56, the piston 80 is displaced downwardly (in the direction of the arrow A). Following this, the valve rod 74 connected to the piston 80 also is displaced downwardly, whereupon the first spring 56 contracts, and the second spring 110 expands.

Thus, the valve plug 76 of the valve element 62 separates away from the valve seat 68, and the initial state shown in FIG. 1 is restored. More specifically, fluid communication between the valve chamber 64 and the decompression chamber 26 is established, thereby placing the pressure reducing valve 10 in an open state.

By repeating the above operation cycle as necessary, the reactant gas, which is kept under high pressure in the ingress passageway 20, is discharged or led out from the egress passageway 28 under a reduced pressure. In other words, the pressure of the reactant gas, which is high in pressure, can be reduced to a predetermined pressure by the reactant gas passing through the interior of the pressure reducing valve 10.

Further, during the process of repeating the stroke displacement of the piston 80 along the axial direction as described above, the first and second wear rings 98, 100 disposed on the outer circumferential surface of the piston 80 are displaced while sliding in contact with the inner circumferential wall of the piston slide hole 24. Therefore, the first and second wear rings 98, 100 experience wear and abrasion, and abrasion particles or debris may be generated, and then adhere to the inner circumferential wall, etc.

However, even in this case, as shown in FIG. 3, the distances C1, C2 between the first and second wear rings 98, 100 and the o-ring 102 are greater than the displacement amount of the piston 80 in the axial direction, i.e., the stroke distance D (C1, C2>D). Therefore, even when the piston 80 undergoes displacement, the o-ring 102 does not move up to the sliding range of the first and second wear rings 98, 100, and thus, for example, abrasion particles that adhere to the inner circumferential wall of the piston slide hole 24 are reliably prevented from coming into contact with or adhering to the o-ring 102.

As a result, damage to the o-ring 102 and deterioration in the sealing performance of the o-ring 102, which are caused by such abrasion particles adhering thereto, can reliably be prevented, and a hermetic or fluid-tight condition between the body 12 and the piston 80 by the o-ring 102 can reliably and stably be maintained.

Further, the two first and second wear rings 98, 100 are provided on the outer circumferential wall of the piston 80 while being separated by a predetermined distance along the axial direction, and by sliding in contact with the inner circumferential wall of the piston slide hole 24, the piston 80 is guided in the axial direction (the direction of arrows A and B). Therefore, inclination of the piston 80 with respect to the piston slide hole 24 can suitably be suppressed, and the piston 80 can be displaced with high precision along the axial direction (the direction of arrows A and B).

Furthermore, the distance in the axial direction between the first annular groove 92 and the second annular groove 94 may be the same as the distance in the axial direction between the third annular groove 96 and the second annular groove 94.

Further, concerning the arrangement of the o-ring 102 and the first and second wear rings 98, 100, the invention is not limited to the embodiment described above. Various aspects can be considered apart from those of the above-described embodiment. For example, both of the first and second wear rings 98, 100 may be disposed on one end side in the axial direction with respect to the o-ring 102. In other words, the first and second wear rings 98, 100 need not necessarily be disposed on the piston 80 on both sides of the o-ring 102 in the axial direction, but may be arranged in a concentrated manner on one end side only of the o-ring 102.

The pressure reducing valve of the present invention is not limited to the above embodiment. Various changes and modifications may be made to the embodiment without departing from the scope of the invention.

What is claimed is:

1. A pressure reducing valve comprising:
a body including an ingress passageway configured to introduce a fluid, a valve chamber held in fluid communication with the ingress passageway, a valve seat disposed in the valve chamber, a valve element being selectively seated on and separated away from the valve seat, a valve hole through which a valve rod with the valve element disposed thereon extends, a decompression chamber held in fluid communication with the valve chamber through the valve hole, and an egress passageway configured to deliver the fluid outside of the decompression chamber;
a piston housed in the body, the piston being coupled to the valve rod for displacement depending on a change in pressure inside the decompression chamber; and
a resilient member configured to resiliently urge the piston toward the valve seat,
wherein, on an outer circumferential wall of the piston, there are provided:
a seal groove in which there is disposed a sealing member configured to slide in contact with an inner circumferential wall of the body; and
a ring groove in which there is disposed a ring member configured to slide in contact with the inner circumferential wall of the body, and
wherein at least one ring groove is disposed on at least one of one side and another side of the seal groove along a direction of displacement of the piston, and a displacement amount of the piston along an axial direction is less than a distance in the axial direction between the seal groove and the ring groove.

2. The pressure reducing valve according to claim 1, wherein a plurality of the ring grooves are provided, with the seal groove being disposed between one of the ring grooves and another of the ring grooves in the direction of displacement of the piston, and the displacement amount of the piston is less than a distance in the direction of displacement between the one of the ring grooves and the seal groove, and also is less than a distance in the direction of displacement between the other of the ring grooves and the seal groove.
